(19) United States
(12) Patent Application Publication
(10) Pub. No.: US 2006/0283293 A1
(43) Pub. Date: Dec. 21, 2006

(54) Device and Method for Cutting Mat and Liner for Double Matted Framed Artwork

(76) Inventor: Allan West, Columbia, SC (US)

Correspondence Address: CALHOUN "REB" THOMAS, III, 1201 MAIN STREET, SUITE 1750, COLUMBIA, SC, 29201, US

(21) Appl. No.: 11/425,509

(22) Filed: Jun. 21, 2006

Related U.S. Application Data
(60) Provisional application No. 60/595,285, filed on Jun. 21, 2005.

(51) Int. Cl. B26D 1/00; B26D 5/08

(52) U.S. Cl. 83/13; 83/581; 83/614

(57) ABSTRACT

The invention is a device and method that allows a user to easily and efficiently hand cut a mat and liner without the need to reposition the mat board. The notched features of the top frame and the different widths of the cutter guides set the parameters for the beginning and of each cut on a mat or a liner for a framed and double matted piece of artwork. Consequently these cuts may be made by a user with limited need for the degree of care which is commonly required in mat cutting using current technology.

### RELATED APPLICATIONS

This application is filed pursuant to a Provisional Patent Application having Application No. 60/595,285 filed on Jun. 21, 2005.

### FEDERALLY SPONSORED RESEARCH OR DEVELOPMENT

Not applicable.

### REFERENCED OR INCORPORATED MATERIAL

Not applicable.

### BACKGROUND OF INVENTION

The present invention relates to a device and a method which allows the user to cut a mat and a liner for specific size picture frames in a manner that is faster and less expensive than present methods such as computerized cutting devices or devices for hand cutting mats. The user of this invention is normally an artist, framer, or dealer who sells prints in an industry standard size in large quantities. The use of this invention can result in significant cost savings and give these users a price advantage.

The use of a hand held cutting device made of a blade holder designed for sliding on flat surfaces and its associated blade (hereinafter the “cutting device”) against a typical straight edge apparatus to cut a mat board is old art. One can review a framing and related products catalogue and see numerous examples of such straight edge devices. Examples of such catalogues include: DickBlick, FramCo, Logan Graphic Products, Curry's Artists Materials, and Framing4yourself.com. The simplest example of these devices may be a straight edge guide similar to a ruler against which a hand-held mat cutter is pressed and slid along to make a straight cut. Other versions may be a straight edge guide with a bar that has a mat cutting device attached in a slidable manner. Other versions involve an “L” shape where the “L” helps to keep the mat at a 90 degree position. Each of these devices requires that the user reposition the mat board after each cut or pair of cuts. This repositioning of the mat board that is being cut provides opportunities for user created error. Typically each straight, beveled side of a mat is cut using a device or devices such as those mentioned above. Also, each of these devices must be set up for each size mat ahead of time before cutting may begin.

Other devices used for cutting mat boards include computer controlled mechanical cutting devices. These devices suffer in comparison to the present invention in that they are substantially more expensive, complex and bulky. Additionally, they cannot typically be used with the same speed and efficiency of the present invention. The inventor believes that the present invention is the only device and method designed for rapidly cutting single or double mats of particular sizes and the only manual version of such device and method where the mat board remains in a fixed position during all four cuts.

### SUMMARY OF THE INVENTION

The present invention relates to a device and method that uses inexpensive components to enable a user to easily and efficiently cut a mat and a liner for use in double matting framed artworks. The invention can be used to cut single mats for similar use, but that is not its primary function. The components can be sized and otherwise configured in ways that allow more than one size mat to be cut on the invention frame. The present invention has been made to solve problems associated with the use and positioning of basic straight edges and “L” shaped guides that are common in the industry. For example, it is common to have to make pencil or other similar marks on the blank mat board where an opening is to be cut. Careful measurements and lines must often be made and this can cause the user to have to spend approximately 3 to 5 minutes marking and cutting each mat board. The present invention allows the mat board to be cut without having to make any such measurements and pencil marks. This is achieved by the use of a preconfigured template or frame of a nature designed to appropriately interact with one or more industry-standard handheld cutting devices. Additionally, the configuration of the present invention components facilitates the speed and safety with which a user can make the desired hand-cut mats.

### BRIEF DESCRIPTION OF THE SEVERAL VIEWS OF THE DRAWINGS

FIG. 1 is an exploded view of the template portion of the invention showing a top frame (70), a mat holder (30), a protective mat board layer (20), and a base (10);

FIG. 2 is a view of two cutter guides showing their differing widths (110 & 120) and their flip over extensions (130), a blank mat board (60) about to be inserted for cutting to be a mat or liner, and an assembled template portion of the invention;

FIG. 3 is a view of the template portion of the invention holding a blank mat board (60) in place, a wide cutter guide (120)(shown without the flip over extension) inserted into position and an standard handheld mat cutting device (200) positioned against the cutter guide (120) in such a manner that it will not fit into the applicable side notch (80) in the top frame of the template;

FIG. 3A is a view of the corner cut-out (50) in the mat holder (30) with the mat board (60) in place;

FIG. 3B is a view of the thumb notch (40) on the side of the mat holder (30) with the mat board (60) in place;

FIG. 4A is a view of a standard handheld mat cutting device (200) being used to make a cut with the wide cutter guide (120)(shown without flip over extension) in such a fashion that the cutting device (200) will not fit in the applicable side notches (80) at either end of the cutter guide (120);

FIG. 4B is a view of a standard handheld mat cutting device (200) being used to make a cut with the narrow cutter guide (110)(shown without flip over extension) in such a fashion that the cutting device (200) will fit in the applicable side notches (80) at either end of the cutter guide (110);

FIG. 5 is a view of an alternative embodiment of the top frame (300) on the template portion of the invention for use with an alternative handheld mat cutting device that is of a different size and orientation thereby requiring different notching (310).

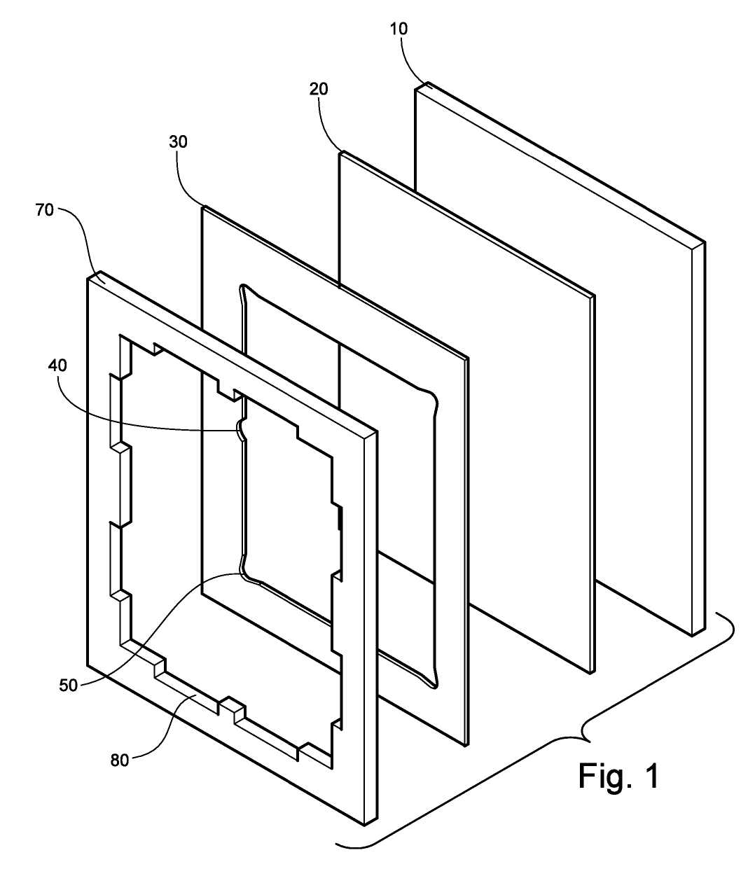

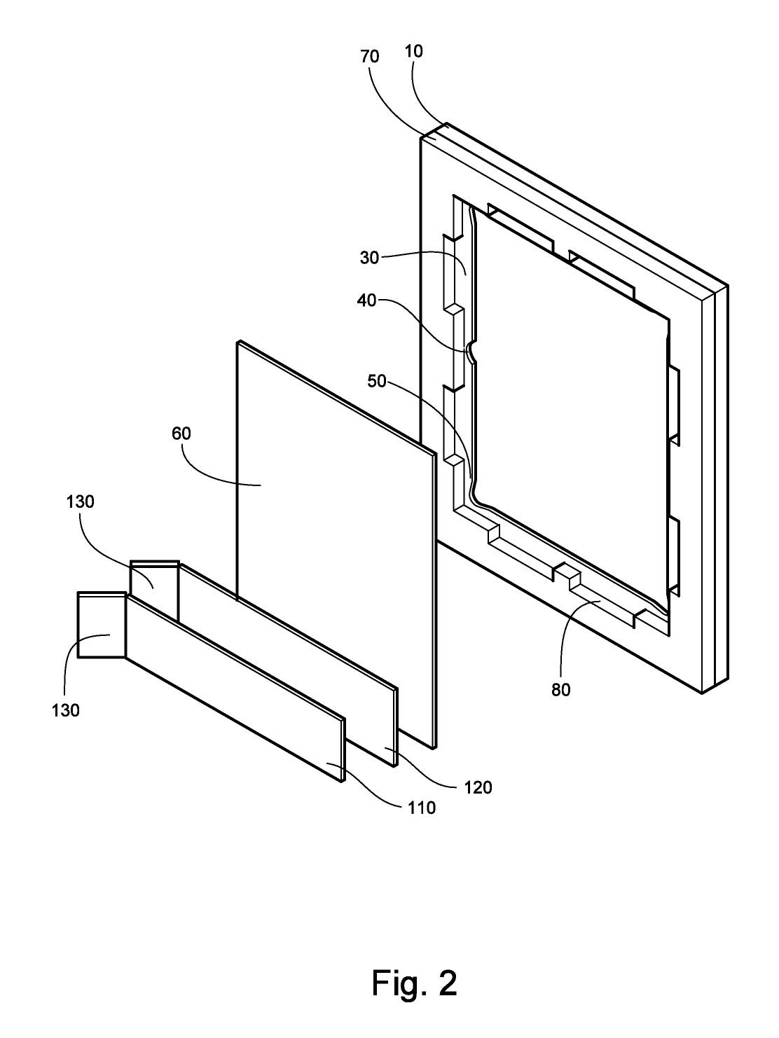

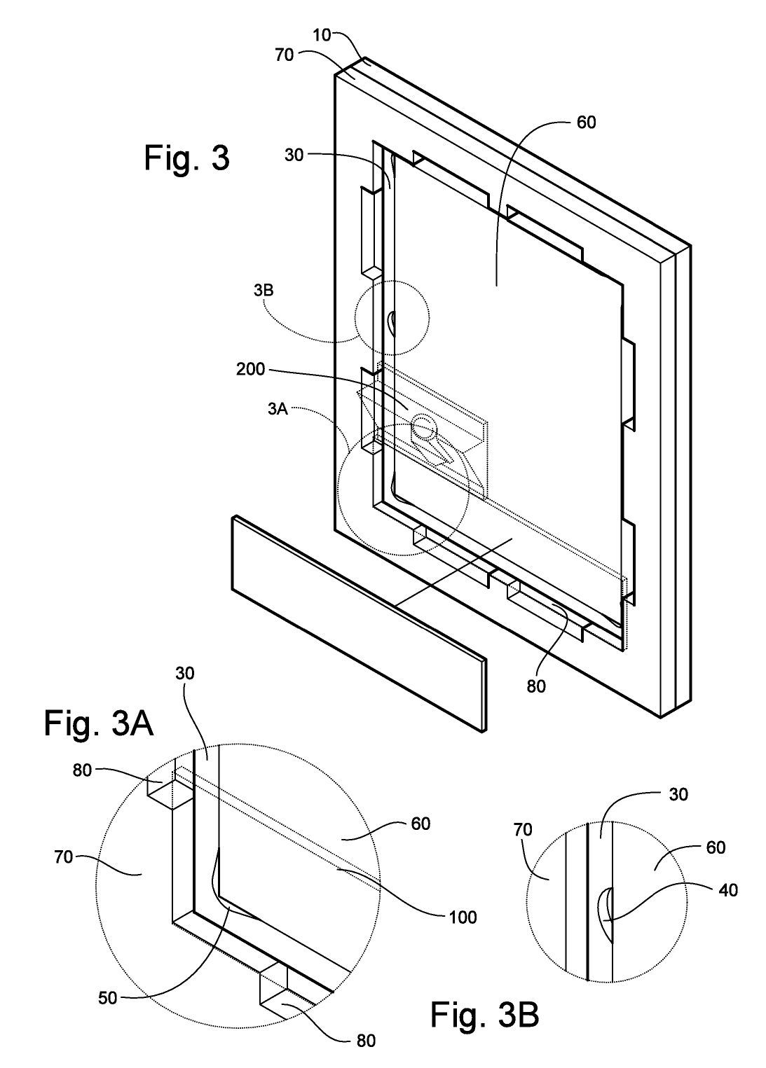

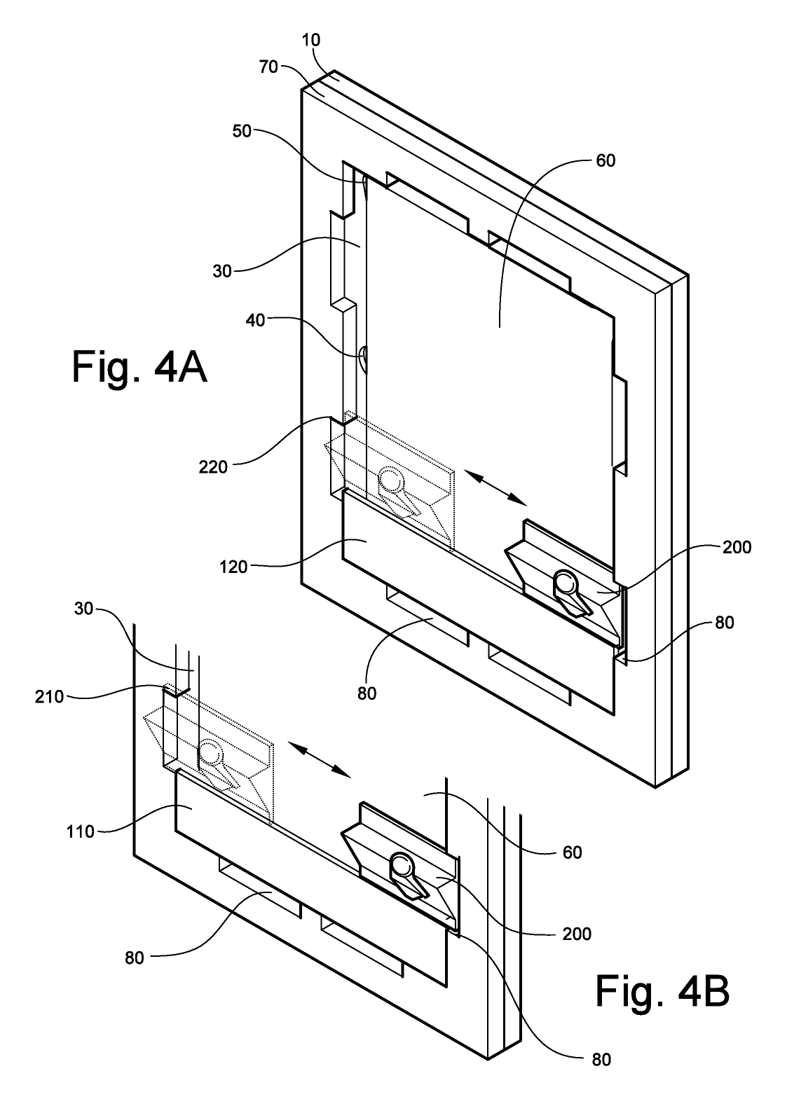

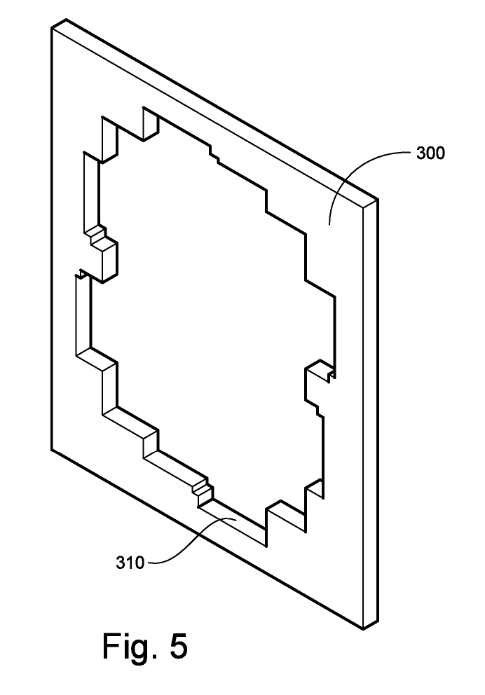

### DETAILED DESCRIPTION

It is to be understood by a person having ordinary skill in the art that the present discussion is a description of exemplary embodiments only, and is not intended as limiting the broader aspects of the present invention. The following example is provided to further illustrate the invention and is not to be construed to unduly limit the scope of the invention.

The preferred embodiment of the present invention contemplates the use of a hand-held cutting device (200). As noted above, these hand-held cutting devices are well known in the industry, however, as used with the present invention the handheld cutting device (200) selected by the user must be within a particular size range to work with the mat cutting template of the present invention. In this embodiment, the template is generally a rectangular base (10) with a top frame (70) containing notches (80) attached. In between the top frame (70) and the base (10) are sandwiched a mat holder (30) and a protective mat board (20). The protective mat board (20) is disposable as its purpose is to keep the tip of the cutting blade of cutting device (200) from coming into contact with the harder surface of the base (10), however, an alternative embodiment of the invention could dispense with this protective mat board (20) and use a base (10) made of material that will withstand occasional contact with the cutting blade of the cutting device (200). The center of the template is flat within the center of the mat holder (30) and this is where a blank mat board (60) is placed to be cut. The mat holder (30) and the blank mat board (60) are of approximately the same thickness. The thumb or finger notches (40) at the sides and the corner notches (50) at the corners of the mat holder make it easier for the user to remove the mat or liner from the mat holder (30). The template can be created to fit industry-standard mat sizes, particularly those for 8″×10″ artworks. In another alternative embodiment for larger sized artworks, the mat holder becomes unnecessary as the frame itself can serve the function of holding the blank mat board (60) in place while being cut. Accordingly, the templates that are used in the mat cutting system of the present invention are sized to fit and securely hold in place blank pieces of mat board of standard sizes, however, they can be sized and configured to be used with other less standard size mat blanks. Moreover, an alternate top frame (300) of the template can be designed to work with cutting devices of varying sizes by adjusting the notch (310) placement, sizing, and orientation.

Each template comes with two cutter guides (110 & 120) that are sized to be used with their particular template. The cutter guides (110 & 120) are the same length, however they are different widths. The difference in their widths is the difference in the opening sizes that are cut into a blank mat board (60) to create a mat and its liner. Thus, according to the different widths, the cutting guides can be classified into narrow cutting guides (110) (for longer cuts for the mat with the larger opening) and wide cutting guides (120) (for shorter cuts for the liner with the smaller opening). Using these two cutter guides and the top frame (70) with notches (80) of the template, the user can efficiently cut two different inside openings in two blank mat boards (60). This gives the user the opportunity to quickly and easily cut both a mat and a liner. The speed with which a mat or its associated liner, if applicable, can be cut can be accelerated from approximately 3 to 5 minutes using current methods common in the industry to approximately 10 seconds using the present invention.

The top frame (70) is notched (80) at the points where the user will want the handheld mat cutting device (200) to cut the largest opening for the mat. The cutter fits (210) into these notches (80) at the beginning and end of a cut along one side of the frame because the narrower cutter guide (110) is used. When the wider cutter guide (120) is used in creating the liner, the cutter is restricted from entering (220) the notched area (80) and consequently the cut opening is slightly smaller. The difference between the widths of the wider cutter guide (120) and narrower cutter guide (110) defines how much of the liner will be visible under the mat in a double matted piece of framed artwork.

Naturally several different materials such as wood, plastic, or metal may be used in the construction of the present invention and these and other modifications and variations may be practiced by one of ordinary skill in the art, without departing from the spirit and scope of the present invention. In addition, it should be understood that aspects of the various embodiments may be interchanged both in whole and in part. Furthermore, those of ordinary skill in the art will appreciate that the foregoing description is by way of example only, and is not intended to limit the invention to be further described in the claims.

What is claimed is:

1. A mat cutting apparatus comprising:
a top frame;
a mat holder fixedly connected to said top frame;
a protective mat board removably connected to said mat holder;
a base fixedly connected to said protective mat board; and
a plurality of cutter guides, each of said cutter guides having a flip over extension for extending the length of said cutting guide when lengthwise cutting is desired.

2. The mat cutting apparatus of claim 1 wherein the top frame further comprises a plurality of notches, said notches having a depth that allows a cutting device to enter said notch for a longer cut.

3. The mat cutting apparatus of claim 2 wherein said plurality of cutter guides are machined to varying widths.

4. The mat cutting apparatus of claim 3 wherein said plurality of cutter guides are machined to a width so as to permit the cutting device to enter said notch of the top frame thereby making a longer cut.

5. The mat cutting apparatus of claim 3 wherein said plurality of cutter guides are machined to a width so as to restrict the cutting device from entering said notch of the top frame thereby making a shorter cut.

6. The mat cutting apparatus of claim 1 wherein said mat holder further comprises a peripheral border having a plurality of side finger notches and corner cut-out notches.

7. A mat cutting apparatus comprising:
a top frame comprising a plurality of notches, said notches having a depth that allows a cutting device to enter said notch for a longer cut;
a mat holder fixedly connected to said top frame comprising a peripheral border having a plurality of finger notches and corner cut-out notches;
a protective mat board removably connected to said mat holder;
a base fixedly connected to said protective mat board;
a plurality of narrow cutter guides machined to a width permitting a cutting device to enter said notch of the top frame thereby making a longer cut, each of said cutter guides having a flip over extension for extending the length of said cutting guide when lengthwise cutting is desired; and
a plurality of wide cutter guides machined to a width restricting a cutting device from entering said notch of the top frame thereby making a shorter cut, each of said cutter guides having a flip over extension for extending the length of said cutting guide when lengthwise cutting is desired.

8. The mat cutting apparatus of claim 7 wherein said plurality of notches is asymmetrically disposed to accommodate cutting devices of less standard size and cutting blade position.

9. A method of cutting a mat which comprises the steps of:
(a) providing a mat board for cutting;
(b) placing said mat board in a structured frame;
(c) determining a width and a length of desired mat border;
(d) positioning a cutting guide corresponding to said width of mat border on top of said mat board to a position in the structured frame;
(e) cutting said mat board width with a cutting device along said cutting guide allowing a cutter to run the full length of the cutting guide inside the structured frame;
(f) repeating steps (d) and (e) for positioning and cutting the second desired width;
(g) positioning a cutting guide corresponding to said length of mat border on top of said mat board to a position in the structured frame;
(h) cutting said mat board length with a cutting device along said cutting guide allowing a cutter to run the full length of the cutting guide inside the structured frame; and
(i) repeating steps (g) and (h) for positioning and cutting the second desired length.

10. The mat cutting method of claim 9 wherein step (b) comprises placing said mat board in a structured frame with a plurality of notches that allow for longer or shorter cuts to be made by the cutting device either fitting into such notches or being blocked from fitting into such notches depending on the cutting guide used.
